(19) United States
(12) Patent Application Publication
(10) Pub. No.: US 2006/0262580 A1
(43) Pub. Date: Nov. 23, 2006

(54) ADAPTER AND METHOD OF DETECTING AND ADJUSTING VOLTAGES AND CURRENTS

(76) Inventor: Jeng-Fuh Liu, Taipei City (TW)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/462,645

(22) Filed: Aug. 4, 2006

(30) Foreign Application Priority Data
Dec. 14, 2005 (TW) 094144166

(51) Int. Cl. H02P 13/00

(52) U.S. Cl. 363/100

(57) ABSTRACT

The present invention provides an adapter and a method of detecting and adjusting voltages and currents for supplying the power requirement of different electronic apparatus. The adapter of present invention comprises an AC input port, a DC input port, a power adjusting circuit and a display device. The display device is set on the surface of the adapter for indicating the presently output voltage and current values from the adapter. The power adjusting circuit comprises a power selection device, an AC to DC converter, a voltage adjusting device, a current regulator, a pulse detector and a micro-controller. The micro-controller is capable of controlling the voltage adjusting device and the current regulator for adjusting the output voltage and current of the adapter according to the responding current detected by the pulse detector. The micro-controller can provide a series of pre-programming voltage step within a controlled pulse. The adapter of present invention can be inputted an AC power or a DC power, and then transform the input power into a DC power as required by the electronic apparatus.

### FIELD OF THE INVENTION

The present invention generally relates to a power adapter and a method of detecting and adjusting voltages and currents, and more particularly, to an adapter and a method capable of detecting and adjusting voltage and current which are required by an electronic apparatus and thereof outputting to the electronic apparatus.

### BACKGROUND OF THE INVENTION

The portable electronic products have become more and more popular in recent days. People carry the portable electronic products everyday, such as mobile phones, laptop PCs, personal digital assistant (PDAs) or digital media players (Apple iPod, MP3 players). Those portable electronic products are not only provided with the mobile communication functions and data storage capability, but also satisfied with the entertaining requirements of users. Most of the portable electronic products are equipped with a rechargeable battery to supply the power required by the portable electronic products. The rechargeable battery can be charged from either an AC power (e.g. 110/220V socket) or a DC power (e.g. 12V cigar-lighter in a car) by an adapter coupled to the portable electronic product.

Conventional adapters are only designed for specific portable electronic products, that is, the connecting interface and output voltage of conventional adapters are only suitable to specific portable electronic products. Typically, a user has to prepare different adapters in order to operate different portable electronic products or charge the rechargeable batteries thereof. A user, therefore, will need to pay higher cost to prepare different adapters. Moreover, users will have great inconvenience of carrying these different adapters.

In addition, a conventional programming power adapter is capable of supplying power according to different portable electronic products. However, a conventional programming power adapter uses a so-called “intelligent tips” to match corresponding portable electronic products. The “intelligent tip” with a pre-determined value or code inside is actually pre-selected by the user for communicating with the programming power adapter through a programming core to supply a required voltage and current for specific portable electronic products. In other words, the output voltage and current of the programming power adapter is pre-selected by the end-user before using the programming power adapter.

Therefore, there is a need to provide a novel adapter and a novel method of detecting and adjusting output voltages and currents for supplying the different power requirement of different portable electronic products.

### SUMMARY OF THE INVENTION

The primary object of the present invention is to provide an adapter of detecting and adjusting voltages and currents for supplying the powers required by different electronic apparatus.

Another object of the present invention is to provide a method of detecting and adjusting voltages and currents for supplying the powers required by different electronic apparatus.

According to the above objects, the present invention sets forth an adapter and a method of detecting and adjusting voltages and currents for supplying the power requirement of different electronic apparatus. The adapter of present invention comprises an AC input port, a DC input port, a power adjusting circuit and a display device. The display device is set on the surface of the adapter for indicating the presently output voltage and current values from the adapter. The power adjusting circuit comprises a power selection device, an AC to DC converter, a voltage adjusting device, a current regulator, a pulse detector and a micro-controller. The micro-controller is capable of controlling the voltage adjusting device and the current regulator for adjusting the output voltage and current of the adapter according to the responding current detected by the pulse detector. The micro-controller can provide a series of pre-programming voltage step within a controlled pulse. According to the Ohm Law: V=I×R, in which V is the pulsed voltage, R is the resident resistance of an electronic apparatus, and I is the responding current. Any potable electronic apparatus has a certain resident resistance and a maximum input current limitation. The present invention uses these two intrinsic electronic properties of potable electronic apparatus to find out the required voltage and current thereof. The adapter of present invention can receive an input of an AC power or a DC power, and then transforms the inputted power into a DC power required by the electronic apparatus.

The method of present invention is capable of detecting the required DC voltage and current of an electronic apparatus, then adjusting the output voltage and current of the adapter. In other words, the present invention can be regarded as an intelligent power supply with a dummy connector to a potable electronic apparatus. The required voltage and current by the potable electronic apparatus are determined by direct communicating between intelligent power supply and the connected potable electronic apparatus.

### BRIEF DESCRIPTION OF THE DRAWINGS

FIG. 1 illustrates a perspective view of an adapter according to the present invention.

FIG. 2 shows the adapter of present invention with another embodiment of display device.

FIG. 3 shows a sliding latch placed in the adapter of present invention.

FIG. 4 illustrates a block diagram of a power adjusting circuit in the adapter of present invention.

FIGS. 5A-5C illustrate a flow chart of the method in accordance with the present invention.

### DETAILED DESCRIPTION OF THE PREFERRED EMBODIMENTS

The present invention is directed to an adapter and a method of detecting and adjusting output voltages and currents for supplying the different powers required by different electronic apparatus.

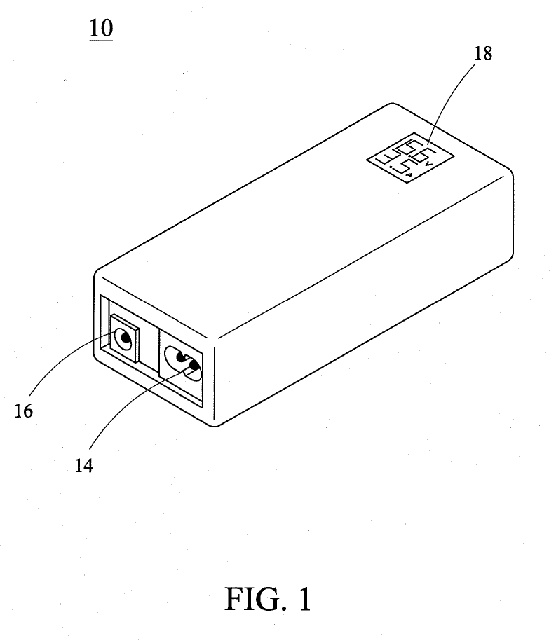

FIG. 1 illustrates a perspective view of an adapter of detecting and adjusting output voltages and currents for supplying the different powers required by different electronic apparatus according to the present invention. The adapter 10 comprises an AC input port 14, a DC input port 16 and a display device 18. The AC input port 14 is used to receive an AC power plug (not shown) for inputting AC power, and the DC input port 16 is used to receive a DC power plug (not shown) for inputting DC power. The display device 18 is set on the surface of adapter 10 in order to indicate the presently output power parameters from the adapter, wherein the power parameters may include voltage or current values. The display device 18 may be a liquid crystal display (LCD) or other display devices.

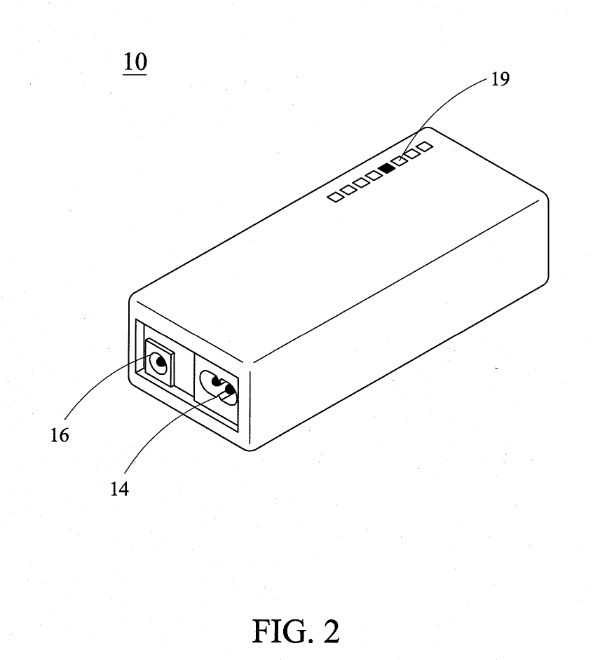

FIG. 2 shows the adapter of present invention with another embodiment of display device. A display device 19 is set on the surface of the adapter 10. The display device 19 is composed of a plurality of light emitting diodes (LED), wherein each LED represents a corresponding output voltage of the adapter 10. Users can judge the presently output voltage of the adapter 10 according to the illuminating status of the plurality of LEDs.

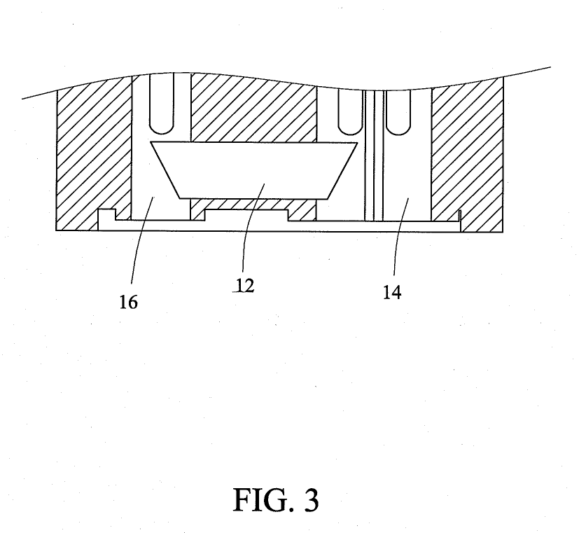

FIG. 3 shows a sliding latch 12 placed in the adapter of present invention. The sliding latch 12 is placed between the AC input port 14 and the DC input port 16 for preventing the AC and DC powers being inputted into the adapter 10 simultaneously. The sliding latch 12 is pushed to obstruct the DC input port 16 when an AC plug (not shown) is inserted into the AC input port 14. Contrarily, the sliding latch 12 is pushed to obstruct the AC input port 14 when a DC plug (not shown) is inserted into the DC input port 16. Consequently, the AC plug and DC plug will not be inserted into the adapter 10 at the same time.

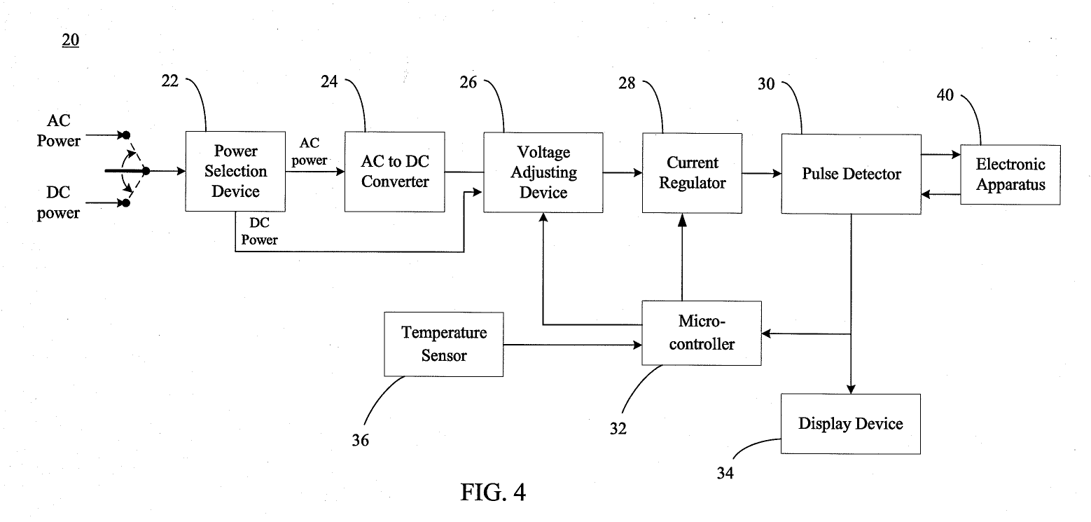

FIG. 4 illustrates a block diagram of a power adjusting circuit in the adapter of present invention. The adapter 10 comprises a power adjusting circuit 20. The power adjusting circuit 20 comprises a power selection device 22, an AC to DC converter 24, a voltage adjusting device 26, a current regulator 28, a pulse detector 30, a micro-controller 32, a display device 34 and a temperature sensor 36. The power selection device 22 is used to select the input power for preventing the AC and DC powers being inputted into the adapter 10 simultaneously. The power selection device 22 can be realized as the sliding latch 12 (shown in FIG. 3) or a power selection circuit to select the input power. An AC power will be inputted into the AC to DC converter 24 for converting the AC power into a converted DC power. The converted DC power is then inputted into the voltage adjusting device 26 for upgrading or downgrading the voltage of the converted DC power. Otherwise, a DC power can be directly inputted into the voltage adjusting device 26 for upgrading or downgrading the voltage of the DC power without the conversion process. The voltage adjusting device 26 is controlled by the micro-controller 32 for adjusting the voltage of DC power. The current regulator 28 is used to stabilize the current of the DC power after the voltage adjusting process for protecting the electronic apparatus 40 from being damaged due to the overloading current. The current regulator 28 is controlled by the micro-controller 32 for adjusting the output current of adapter 10. The pulse detector 30 is capable of detecting the polarity of input interface and required input power of electronic apparatus 40 and transmitting the detecting result to the micro-controller 32. The micro-controller 32 controls the voltage adjusting device 26 to upgrade or downgrade the voltage of the DC power for supplying the required power of electronic apparatus 40. Additionally, the pulse detector 30 detects the output voltage and current of adapter 10 then transmits the detecting result to the display device 34 for displaying presently output voltage and current of the adapter 10. The display device 34 may be a liquid crystal display, a LED display or other display devices. The temperature sensor 36 is used to protect the adapter 10. The temperature sensor 36 will shut down the power output if the inside temperature of the adapter reaches a predetermined temperature, such as 80 degrees centigrade. Further, the adapter will be restored if the inside temperature goes back to the room temperature.

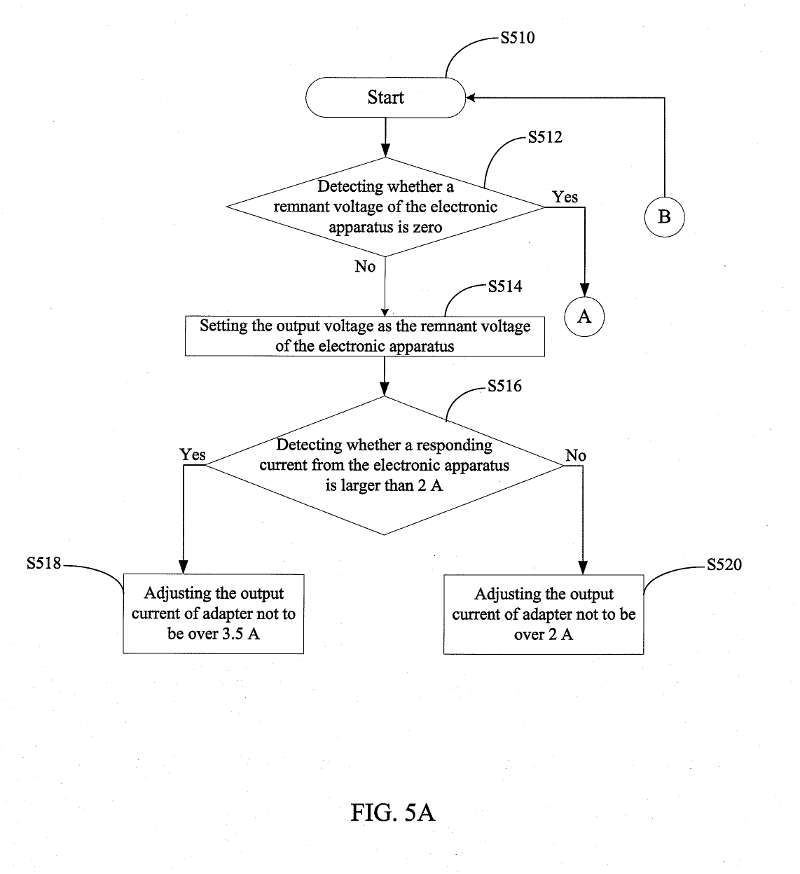

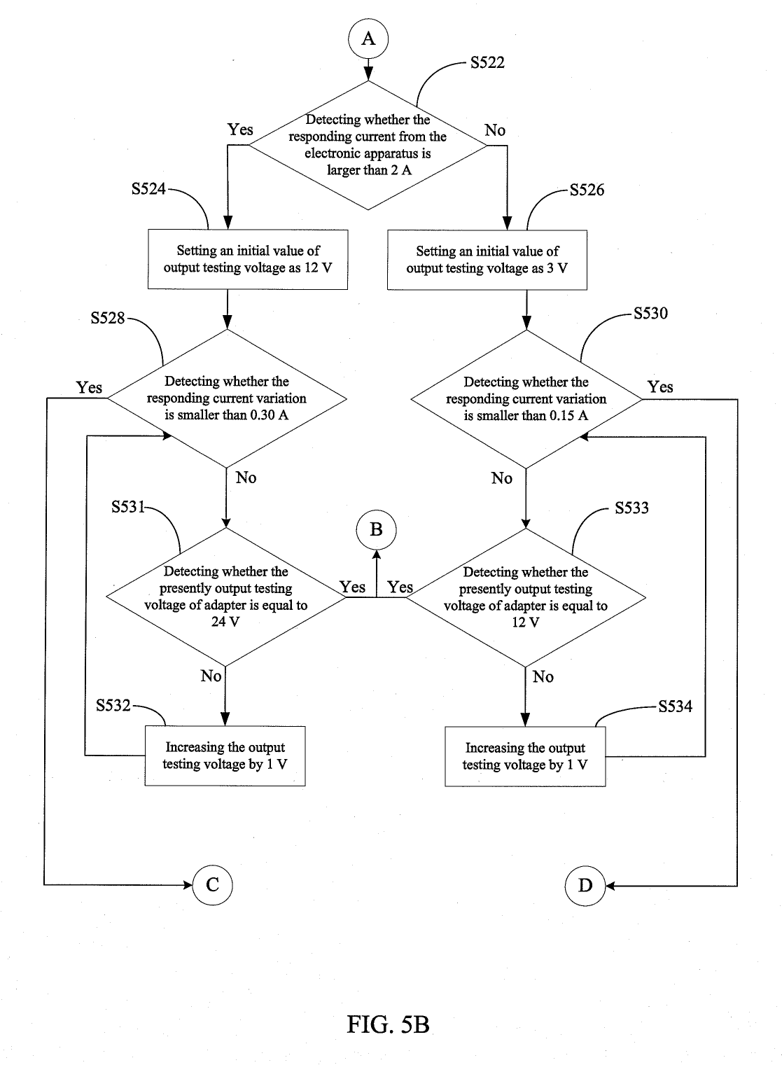

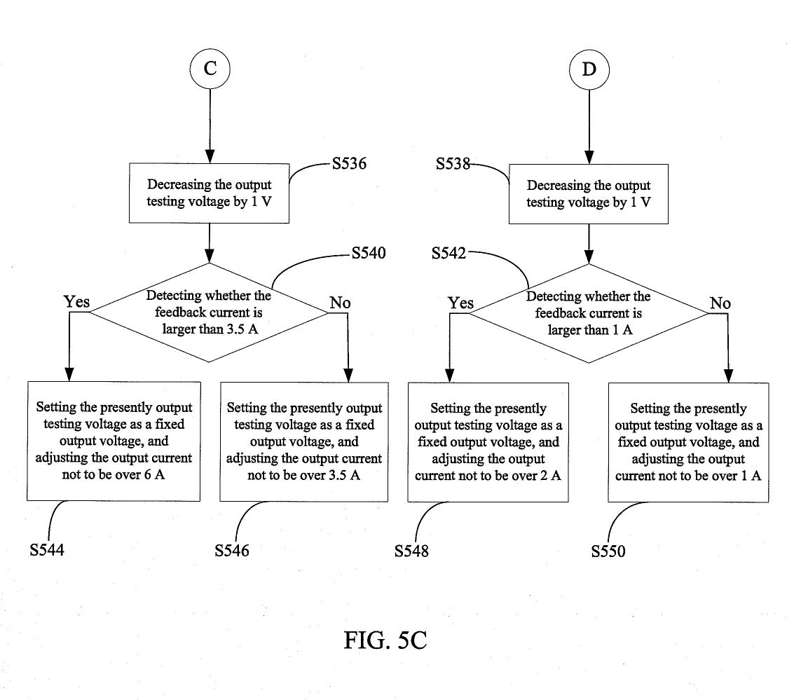

FIGS. 5A-5C illustrate a flow chart of the method in accordance with the present invention. The method is capable of detecting the required voltage of electronic apparatus at first, then the micro-controller 32 controls the voltage adjusting device 26 to adjust the voltage of DC power. Accordingly, the output voltage and current of adapter 10 will meet the requirement of the electronic apparatus. The method comprises following steps of:

| | |
|---|---|
| S510 | Starting the process of detecting and adjusting output voltage and current |
| | under an open circuit status without any load. The open circuit can be |
| | determined by an RC detecting circuit: Vt = V0 × Exp(−t/Rc). For example, if |
| | V0 = 3.0 V, Vt = 0.3 V, C = 4μF, R is a resident resistance of the electronic |
| | apparatus, t is a discharge time until Vt equals to 0.3 V, when R is larger than |
| | 1MΩ means that the circuit is in an open circuit status. The pulse detector 30 |
| | checks the power polarity of input interface of the electronic apparatus if R is |
| | smaller than 1MΩ in order to set the output power polarity of adapter 10 |
| | corresponding to the power polarity of input interface of the electronic |
| | apparatus. |
| S512 | The pulse detector 30 detects whether a remnant voltage of the electronic |
| | apparatus is zero. The remnant voltage means that there is remaining voltage |
| | of the rechargeable battery equipped with the electronic apparatus. The |
| | remnant voltage can directly indicate the required input voltage of the |
| | electronic apparatus. The zero remnant voltage means that the electronic |
| | apparatus has an anti-reversing diode circuit. If the remnant voltage of the |
| | electronic apparatus is zero, then go forward to step S522, otherwise go |
| | forward to step S514. |
| S514 | The micro-controller 32 controls the voltage adjusting device 26 to adjust the |
| | output voltage of adapter 10. The output voltage of adapter 10 is adjusted to |
| | meet the remnant voltage of the electronic apparatus and outputted to the |
| | electronic apparatus. |
| S516 | According to the output voltage of adapter 10, the pulse detector 30 detects |
| | whether a responding current from the electronic apparatus is larger than 2 A. |
| | If the responding current from the electronic apparatus is larger than 2 A, then |
| | go forward to step S518; otherwise go forward to step S520. |
| S518 | The micro-controller 32 controls the current regulator 28 to adjust the output |
| | current of adapter 10 not to be over 3.5 A, and output the stably output voltage |
| | and current to the electronic apparatus. |
| S520 | The micro-controller 32 controls the current regulator 28 to adjust the output |
| | current of adapter 10 not to be over 2 A, and output the stably output voltage |
| | and current to the electronic apparatus. |
| S522 | The pulse detector 30 detects whether the responding current from the |
| | electronic apparatus is larger than 2 A. If the responding current from the |
| | electronic apparatus is larger than 2 A, then go forward to step S524; |
| | otherwise go forward to step S526. |
| S524 | The micro-controller 32 controls the voltage adjusting device 26 to adjust the |
| | ouput voltage of adapter 10. An initial value of output testing voltage of |
| | adapter 10 is adjusted to 12 V then outputted to the electronic apparatus for |
| | determining the required voltage thereof. The process goes forward to step |
| | S528. |
| S526 | The micro-controller 32 controls the voltage adjusting device 26 to adjust the |
| | ouput voltage of adapter 10. An initial value of output testing voltage of |
| | adapter 10 is adjusted to 3 V then outputted to the electronic apparatus for |
| | determining the required voltage thereof. The process goes forward to step |
| | S530. |
| S528 | The pulse detector 30 detects and checks whether a responding current |
| | variation of the electronic apparatus is smaller than 0.30 A after the presently |
| | output testing voltage outputted to the electronic apparatus. If the responding |
| | current variation of the electronic apparatus is smaller than 0.30 A, then go |
| | forward to step S536; otherwise go forward to step S531. |
| S530 | The pulse detector 30 detects and checks whether the responding current |
| | variation of the electronic apparatus is smaller than 0.15 A after the presently |
| | output testing voltage outputted to the electronic apparatus. If the responding |
| | current of the electronic apparatus is smaller than 0.15 A, then go forward to |
| | step S538; otherwise go forward to step S533. |
| S531 | The pulse detector 30 detects whether the presently output testing voltage of |
| | adapter 10 is equal to 24 V. If the presently output testing voltage of adapter |
| | 10 is equal to 24 V, then go backward to step S510; otherwise go forward to |
| | step S532. |
| S532 | The micro-controller 32 controls the voltage adjusting device 26 to increase |
| | the output testing voltage of adapter 10 by 1 V then output to the electronic |
| | apparatus for determining the required voltage thereof once again. The |
| | process goes backward to step S528. |
| S533 | The pulse detector 30 detects whether the presently output testing voltage of |
| | adapter 10 is equal to 12 V. If the presently output testing voltage of adapter |
| | 10 is equal to 12 V, then go backward to step S510; otherwise go forward to |
| | step S534. |
| S534 | The micro-controller 32 controls the voltage adjusting device 26 to increase |
| | the output testing voltage of adapter 10 by 1 V then output to the electronic |
| | apparatus for determining the required voltage thereof once again. The |
| | process goes backward to step S530. |
| S536 | The micro-controller 32 controls the voltage adjusting device 26 to decrease |
| | the output testing voltage of adapter 10 by 1 V then output to the electronic |
| | apparatus for determining whether the output testing voltage meets the |
| | required voltage of the electronic apparatus. The process goes forward to |
| | step S540. |
| S538 | The micro-controller 32 controls the voltage adjusting device 26 to decrease |
| | the output testing voltage of adapter 10 by 1 V then output to the electronic |
| | apparatus for determining whether the output testing voltage meets the |
| | required voltage of the electronic apparatus. The process goes forward to |
| | step S542. |
| S540 | The pulse detector 30 detects whether the responding current from the |
| | electronic apparatus is larger than 3.5 A. If the responding current from the |
| | electronic apparatus is larger than 3.5 A, then go forward to step S544; |
| | otherwise go forward to step S546. |
| S542 | The pulse detector 30 detects whether the responding current from the |
| | electronic apparatus is larger than 1 A. If the responding current from the |
| | electronic apparatus is larger than 1 A, then go forward to step S548; |
| | otherwise go forward to step S550. |
| S544 | The micro-controller 32 controls the voltage adjusting device 26 to set the |
| | presently output testing voltage as a fixed output voltage of adapter 10, and |
| | controls the current regulator 28 to adjust the output current of adapter 10 not |
| | to be over 6.0 A. Finally, the adapter 10 outputs the fixed output voltage and |
| | current to the electronic apparatus. |
| S546 | The micro-controller 32 controls the voltage adjusting device 26 to set the |
| | presently output testing voltage as the fixed output voltage of adapter 10, and |
| | controls the current regulator 28 to adjust the output current of adapter 10 not |
| | to be over 3.5 A. Finally, the adapter 10 outputs the fixed output voltage and |
| | current to the electronic apparatus. |
| S548 | The micro-controller 32 controls the voltage adjusting device 26 to set the |
| | presently output testing voltage as the fixed output voltage of adapter 10, and |
| | controls the current regulator 28 to adjust the output current of adapter 10 not |
| | to be over 2.0 A. Finally, the adapter 10 output the fixed output voltage and |
| | current to the electronic apparatus. |
| S550 | The micro-controller 32 controls the voltage adjusting device 26 to set the |
| | presently output testing voltage as the fixed output voltage of adapter 10, and |
| | controls the current regulator 28 to adjust the output current of adapter 10 not |
| | to be over 1.0 A. Finally, the adapter 10 outputs the fixed output voltage and |
| | current to the electronic apparatus. |

According to the aforementioned steps, the method of present invention is capable of detecting the required DC voltage and current of an electronic apparatus, then adjusting the output voltage and current of the adapter to meet the required voltage and current of the electronic apparatus. The method of present invention is not only capable of providing a stably power required by the electronic apparatus, but also protecting the electronic apparatus from damages due to overloading output voltage or current. Therefore, the method of present invention is suitable for any electronic apparatus which requires a rated voltage in the range from 3 V to 24 V, e.g. laptop PC, LCD display, mobile phone, digital media player (Apple iPod, MP3 player), PDA, etc.

The adapter and method of present invention can receive an AC input power or a DC input power, and automatically convert the input power into the require voltage and current of electronic apparatus. In accordance, the adapter according to the present invention is suitable for supplying the required power to various kinds of electronic apparatus thereof. The inconvenience of carrying different adapters can be averted. Furthermore, the adapter of present invention comprises the power selection device for selecting the input power in order to prevent the AC and DC powers being inputted into the adapter simultaneously. The adapter of present invention can receive AC or DC powers by user demand.

As it is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method for detecting and adjusting voltage and current required by an electronic apparatus, which comprising the steps of:
detecting a remnant voltage of the electronic apparatus;
adjusting an output voltage to meet the remnant voltage and outputting the output voltage to the electronic apparatus;
detecting whether a responding current from the electronic apparatus is larger than a first current value;
adjusting an output current not to be over a second current value if the responding current is larger than the first current value; and
adjusting the output current not to be over a third current value if the responding current is not larger than the first current value.

2. The method of claim 1, wherein the first current value is 2 A.

3. The method of claim 1, wherein the second current value is 3.5 A.

4. The method of claim 1, wherein the third current value is 2 A.

5. A method for detecting and adjusting voltage and current required by an electronic apparatus, the method comprising the steps of:
detecting a responding current from the electronic apparatus;
adjusting a testing voltage as a first voltage value if the responding current is larger than a first current value, then outputting the testing voltage to the electronic apparatus;
adjusting the testing voltage as a second voltage value if the responding current is not larger than a first current value, then outputting the testing voltage to the electronic apparatus;
detecting a variation of the responding current after the testing voltage outputted to the electronic apparatus;
increasing the testing voltage by a voltage difference if a responding current variation is not smaller than a second current value, then outputting the testing voltage to the electronic apparatus for detecting the responding current repeatedly;
setting a fixed output voltage as the presently testing voltage if the responding current is larger than a third current value; and
adjusting an output current not to be over a fourth current value if the responding current is larger than the third current value; and
adjusting the output current not to be over a fifth current value if the responding current is not larger than the third current value.

6. The method of claim 5, after the step of detecting a variation of the responding current, further comprising following step of:
decreasing the testing voltage by the voltage difference if the responding current variation is smaller than the second current value and outputting the testing voltage to the electronic apparatus for detecting the responding current repeatedly.

7. The method of claim 5, before the step of increasing the testing voltage by a voltage difference, further comprising following steps of:
detecting whether the presently output testing voltage of the adapter is equal to a third voltage value;
restarting the method if the presently output testing voltage of the adapter is equal to the third voltage value.

8. The method of claim 7, wherein the third voltage value is 24 V if the responding current is larger than the first current value.

9. The method of claim 7, wherein the third voltage value is 12 V if the responding current is not larger than the first current value.

10. The method of claim 5, wherein the first voltage value is 12 V, the second voltage value is 3 V, the first current value is 2 A, the second current value is 0.30 A, the third current value is 3.5 A, the fourth current value is 6.0 A, and the fifth current value is 3.5 A.

11. The method of claim 5, wherein the first voltage value is 12 V, the second voltage value is 3 V, the first current value is 2 A, the second current value is 0.15 A, the third current value is 1 A, the fourth current value is 2 A, and the fifth current value is 1 A.

12. The method of claim 5, wherein the voltage difference is 1 V.

13. An adapter for detecting and adjusting voltage and current required by an electronic apparatus, which comprising:
an AC input port for inputting an AC power into the adapter;
a DC input port for inputting a DC power into the adapter;
an AC to DC converter for converting the AC power into a converted DC power;
a voltage adjusting device for adjusting an output voltage of adapter;
a current regulator for adjusting and stabilizing an output current of the adapter;
a pulse detector for detecting a polarity of input interface and responding voltage and current of the electronic apparatus;
a temperature sensor for detecting an inside temperature of the adapter,
a micro-controller for controlling the voltage adjusting device and the current regulator to adjusting the output voltage and current of the adapter according the responding voltage and current of the electronic apparatus; and
a display device for indicating a presently output power parameter from the adapter.

14. The adapter of claim 13, wherein the output power parameter indicated by the display device comprises the output voltage and current values of the adapter.

15. The adapter of claim 14, wherein the display device is a liquid crystal display.

16. The adapter of claim 13, wherein the display device is composed of a plurality of light emitting diodes.

17. The adapter of claim 13, wherein responding voltage and current of the electronic apparatus are a DC voltage and a DC current.

18. The adapter of claim 13, further comprising a power selection device for selecting an input power of the adapter between the AC and DC powers.

19. The adapter of claim 18, wherein the power selection device is a sliding latch placed between the AC input port and the DC input port for preventing the AC and DC powers are inputted into the adapter simultaneously.
